(19) United States
(12) Patent Application Publication
(10) Pub. No.: US 2018/0104786 A1
(43) Pub. Date: Apr. 19, 2018

(54) DEVICE FOR SIMULTANEOUSLY SUPPLYING FLUIDS

(71) Applicant: KOREA INSTITUTE OF INDUSTRIAL TECHNOLOGY, Cheonan-si, Chungcheongnam-do (KR)

(72) Inventors: Kyung Hee PARK, Cheonan-si, Chungcheongnam-do (KR); Dong Yoon LEE, Seoul (KR); Seok Woo LEE, Seongnam-si, Gyeonggi-do (KR); Tae-Gon KIM, Seongnam-si, Gyeonggi-do (KR)

(73) Assignee: KOREA INSTITUTE OF INDUSTRIAL TECHNOLOGY, Cheonan-si, Chungcheongnam-do (KR)

(21) Appl. No.: 15/516,414

(22) PCT Filed: Oct. 2, 2015
(86) PCT No.: PCT/KR2015/010444

§ 371 Date: Apr. 3, 2017

(30) Foreign Application Priority Data
Oct. 2, 2014 (KR) 10-2014-0132952

(51) Int. Cl. B23Q 11/10; B23Q 3/06

(52) U.S. Cl. CPC B23Q 11/1076; B23Q 11/14; B23Q 11/1084; B23Q 3/064

(57) ABSTRACT

A device for simultaneously supplying fluids comprises: a fixing unit provided with a first flow path through which a first fluid flows, a second flow path through which a second fluid flows, and a through-hole; a rotation unit, which is rotatably provided on the through-hole, which is provided at the front end with a fixing hole into which a processing tool is inserted and fixed, and a communication part which communicates with the first flow path and the fixing hole; and a spray unit of which one side is connected to the second flow path and the other side is provided with a spray flow path having a nozzle for spraying the second fluid on an area to be processed by the processing tool, wherein the spray unit is provided on the fixing unit.

### TECHNICAL FIELD

The present invention relates to a fluid supply device configured to spray fluid and, more particularly, to a device for simultaneously supplying fluids, which simultaneously supplies a first fluid and a second fluid to a processing tool.

### BACKGROUND ART

In general, in a process of processing an object such as metal, heat having high temperature is generated to cause dangers of deforming and damaging a workpiece and cause wear and deformation of tools configured to perform processing as well. Thus, when an object processing operation is performed to prevent the deformation, the damage and the wear, cryogenic fluid for cooling, such as liquid nitrogen, cutting oil for reducing friction or the wear of the tools, and the like are sprayed to an area to be processed.

However, in the related art, a system for spraying the cryogenic fluid and the cutting oil is manufactured by separate devices. Thus, in the related art, the cryogenic fluid and the cutting oil are sprayed to the area to be processed through supply devices thereof.

In this case, there are problems in that because a space occupied by the devices when the object is processed is large, the space is largely wasted, and because a plurality of workers are required to simultaneously control the devices, labor power is wasted.

Further, at this time, it is required to harmoniously adjust supply amounts of the cryogenic fluid and the cutting oil to improve processing quality. However, because the plurality of workers are in charge of the supply devices, respectively, the processing quality deteriorates when a team work of the workers is bad.

In addition, there is a problem in that because a probability that the workers are exposed to danger is large, a safety accident may occur.

Thus, a method for solving the above problems is required.

### DISCLOSURE

### Technical Problem

The present invention is conceived to solve the above-described problems of the related art, and an aspect of the present invention is to provide a device for simultaneously supplying fluids, which is configured to simultaneously supply a plurality of fluids to a processing tool, thereby improving processing quality and preventing a space and labor power from being wasted.

Problems of the present invention are not limited to the above-described problems, and other not-described problems could be clearly understood by those skilled in the art with reference to the following descriptions.

### Technical Solution

A device for simultaneously supplying fluids for achieving the above aspects according to the present invention may include: a fixing unit including a first passage through which a first fluid flows, a second passage through which a second fluid flows, and a through-hole; a rotation unit rotatably provided in the through-hole to pass through the fixing unit, having a fixing hole, into which a processing tool is fixedly inserted, at a front end thereof, having a communication part configured to allow the first passage and the fixing hole to communicate with each other, and configured to supply the first fluid to the processing tool through rotation; and spraying units connected to the second passage on one sides thereof, having spraying passages having nozzles through which the second fluid is sprayed to a portion to be processed, which is processed by the processing tool, on the other sides thereof, and provided in the fixing unit.

Further, the fixing unit may include: a first connection port connected to a first fluid supply device configured to supply the first fluid, and configured to supply the first fluid to the first passage; and a second connection port connected to a second fluid supply device configured to supply the second fluid, and configured to supply the second fluid to the second passage.

Further, the other side of the first passage may be exposed to the through-hole.

Further, the communication part may include: a communication passage formed along a circumference of the rotation unit and configured to communicate with the other side of the first passage; and transfer passages configured to transfer the first fluid having been transferred to the communication passage through the first passage, to the fixing hole.

Further, the plurality of transfer passages may be formed.

Further, the communication part may further include a passing passage which is formed on a rear side of the fixing hole to communicate with the fixing hole and through which the first fluid having been transferred through the transfer passages is supplied to the fixing hole.

Further, the passing passage may be formed at a center of the communication passage with respect to a cross section of the rotation unit.

Further, a vacuum part for insulation may be formed at a circumference of at least one of the first passage and the second passage.

Further, the vacuum part may have a tube shape.

Further, the plurality of spraying units are provided to surround a circumference of the rotation unit, and the fixing unit includes a connection passage allowing the second passage and the spraying passages of the plurality of spraying units to communicate with each other.

Further, the plurality of spraying units are spaced apart from a central point of the rotation unit by a uniform distance.

Further, a hollow hole may be formed in the processing tool, and the first fluid having been transferred to the fixing hole is supplied to the portion to be processed through the hollow hole of the processing tool.

Further, a sealing member configured to prevent leakage of the first fluid may be provided between the fixing unit and the rotation unit.

### Advantageous Effects

A device for simultaneously supplying fluids for solving the above problems according to the present invention has the following effects.

First, there is an advantage in that a plurality of fluids may be simultaneously supplied to a processing tool using one device, so that a space and labor power may be prevented from being wasted.

Second, there is an advantage in that some fluids are directly supplied from a rear side of the processing tool, so that use of the fluids may be minimized.

Third, there is an advantage in that supply amounts of the plurality of fluids may be easily adjusted, so that a user may effectively cope with situations depending on processing conditions required when an object is processed.

Fourth, there is an advantage in that a lifespan of the tool may be increased.

Fifth, there is an advantage in that safety of a worker may be achieved at work, and a working environment may be made comfortable.

Effects of the present invention are not limited to the above-described effects, and other not-mentioned effects could be clearly understood by those skilled in the art with reference to the appended claims.

### BRIEF DESCRIPTION OF THE DRAWINGS

FIG. 1 is a perspective view illustrating a device for simultaneously supplying fluids according to an embodiment of the present invention;

FIG. 2 is a sectional view illustrating a longitudinal cross section of the device for simultaneously supplying fluids according to the embodiment of the present invention;

FIG. 3 is a sectional view taken along line A-A of the device for simultaneously supplying fluids according to the embodiment of the present invention;

FIG. 4 is a sectional view taken along line B-B of the device for simultaneously supplying fluids according to the embodiment of the present invention;

FIG. 5 is a sectional view illustrating a flow path of fluid, in the device for simultaneously supplying fluids according to the embodiment of the present invention; and

FIG. 6 is a sectional view illustrating a first passage of the device for simultaneously supplying fluids according to another embodiment of the present invention.

### BEST MODE FOR THE INVENTION

Hereinafter, exemplary embodiments of the present invention, which may implement the aspects of the present invention in detail, will be described with reference to the accompanying drawings. In description of the present embodiment, the same elements are designated by the same names and the same reference numerals, and additional description according thereto will be omitted.

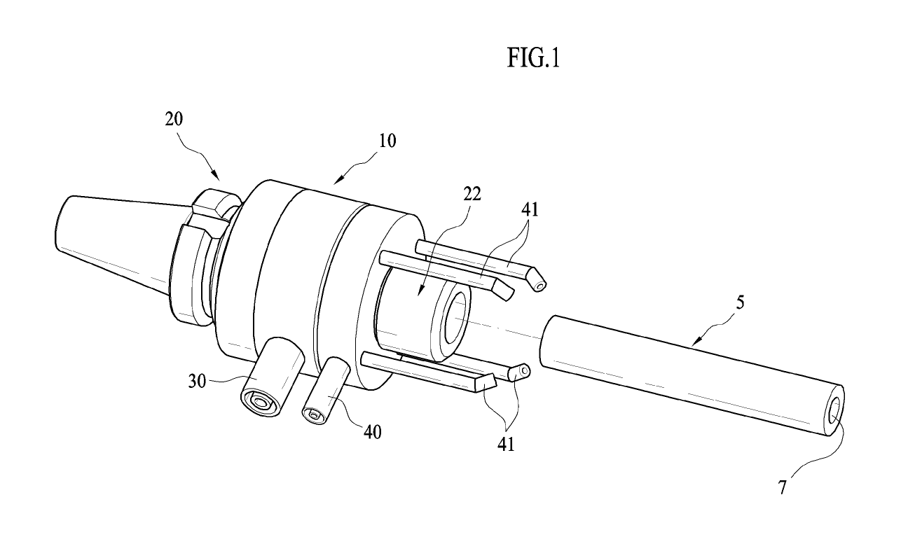

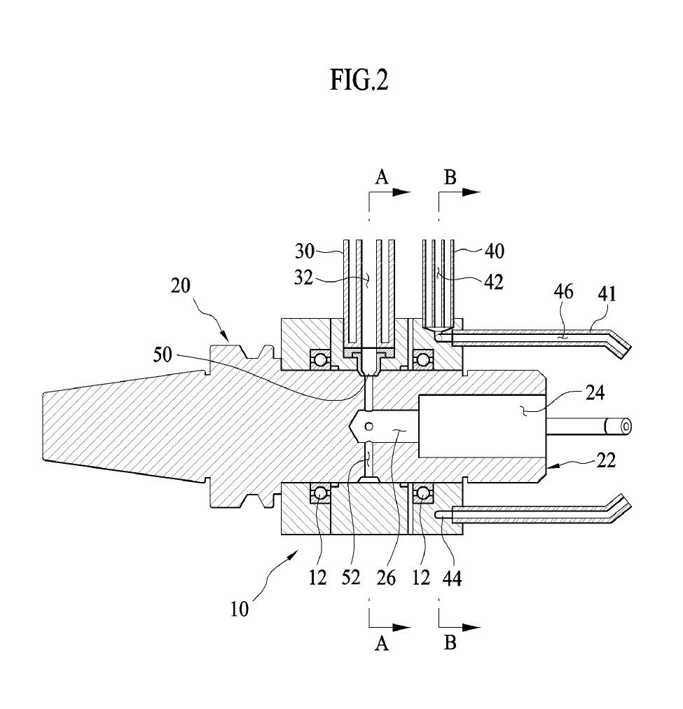

FIG. 1 is a perspective view illustrating a device for simultaneously supplying fluids according to an embodiment of the present invention, and FIG. 2 is a sectional view illustrating a longitudinal cross section of the device for simultaneously supplying fluids according to the embodiment of the present invention.

As illustrated in FIGS. 1 and 2, the device for simultaneously supplying fluids according to the embodiment of the present invention includes a fixing unit 10, a rotation unit 20 and spraying units 41.

The fixing unit 10 has a through-hole formed on an inner side thereof and has a first passage 32 and a second passage 42 formed therein. The first passage 32 defines a path through which a first fluid flows and the second passage 42 defines a path through which a second fluid flows.

The first fluid and the second fluid may be various kinds of fluids supplied to a portion to be processed during processing. In the present embodiment, the first fluid is a cryogenic fluid that lowers processing heat at the portion to be processed, such as liquid nitrogen, and the second fluid is cutting oil that performs a lubrication operation during processing.

However, the first fluid and the second fluid may be fluids that are different from those of the present embodiment. Further, the first fluid may be the cutting oil and the second fluid may be the cryogenic fluid.

Meanwhile, as described above, in the present embodiment, the fixing unit 10 has the first passage 32 and the second passage 42 formed therein, and a first connection port 30 and a second connection port 40 are formed on one sides of the first passage 32 and the second passage 42, respectively.

The first connection port 30 is a component that may be connected to a first fluid supply device configured to supply the first fluid, and supplies the first fluid to the first passage 32 while being connected to the first fluid supply device through a connector such as a hose.

Further, the second connection port 40 is a component that may be connected to a second fluid supply device configured to supply the second fluid, and supplies the second fluid to the second passage 42.

Here, the first fluid supply device and the second fluid supply device may be accommodation tanks in which the first fluid and the second fluid are accommodated, respectively, and may be formed integrally with the device for simultaneously supplying fluids according to the present invention. Further, the first fluid supply device and the second fluid supply device may further include a pressure applying module configured to supply the first fluid and the second fluid at predetermined pressure.

Meanwhile, the other side of the first passage 32 is exposed to the through-hole, and accordingly, the first passage 32 communicates with a communication part of the rotation unit 20, which will be described below. Further, the other side of the second passage 42 communicates with spraying passages 46 of the spraying units 41, which will be described below.

The rotation unit 20 is rotatably provided in the through-hole of the fixing unit 10 to pass through the fixing unit 10. Further, a fixing hole 24 into which a processing tool 5 is fixedly inserted is formed at a front end 22 of the rotation unit 20, and a communication part allowing the first passage 43 of the fixing unit 10, which has been described above, and the fixing hole 24 to communicate with each other is formed.

In the present embodiment, the rotation unit 20 extends in a front-rear direction and protrudes in the front-rear direction while passing through the fixing unit 10. Further, the rotation unit 20 is rotated about a central point of a cross section thereof, and may further include a driving part configured to transfer rotational driving force to the rotation unit 20, although not illustrated.

Further, bearings 12 for smooth rotation of the rotation unit 20 may be provided at the fixing unit 10, and a sealing member configured to prevent leakage of the fluids may be further provided between the fixing unit 10 and the rotation unit 20.

Further, various processing tools 5 may be fixed to the fixing hole 24 formed at the front end 22 of the rotation unit 20, and in the present embodiment, a cutting tool for cutting an object is fixed. Further, a hollow hole 7 is formed in the processing tool 5, and will be described below.

Meanwhile, in the present embodiment, the communication part includes a communication passage 50, transfer passages and a passing passage 26, and detailed descriptions thereof will be also described below.

The spraying units 41 are connected to the second passage 42 on one sides thereof and has the spraying passages 46 having nozzles configured to spray the second fluid to the portion to be processed, which is processed by the processing tool 5, on the other sides thereof.

Further, in the present embodiment, the plurality of spraying units 41 are formed in the fixing unit 10 to surround a circumference of the rotation unit 20. Further, the other ends of the spraying units 41 are bent at a predetermined angle so that the second fluid is sprayed to an accurate location. Here, the spraying passages 46 of the spraying units 41 may communicate with each other by a connection passage 44.

Hereinafter, the communication part of the rotation unit 20 and the spraying passages 46 and the connection passage 44 of the spraying unit 41 will be described in detail.

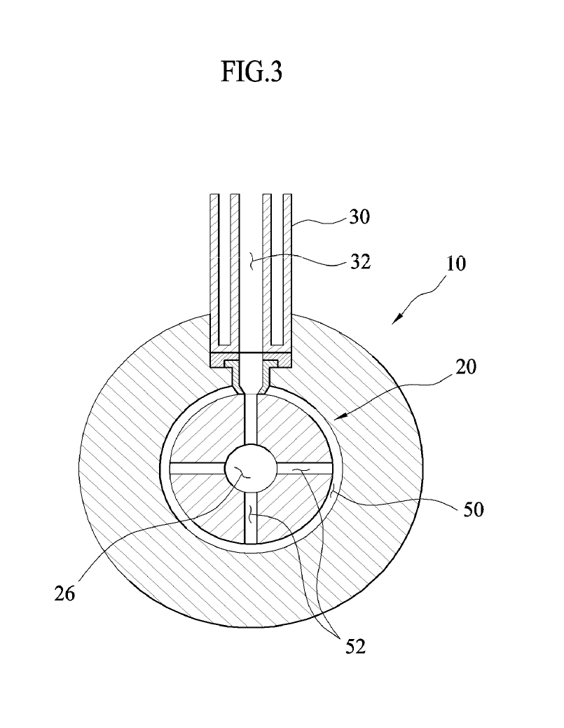

FIG. 3 is a sectional view taken along line A-A of the device for simultaneously supplying fluids according to the embodiment of the present invention.

As illustrated in FIG. 3, the communication passage 50 is formed along a circumference of the rotation unit 20 and communicates with the other side of the first passage 32.

Further, the transfer passages 52 transfers the first fluid having been transferred to the communication passage 50 through the first passage 32, to the fixing hole 24. In the present embodiment, the passing passage 26 is further formed between the fixing hole 24 and the transfer passages 52, so that the first fluid and the second fluid are transferred to the fixing hole 24 via the passing passage 26.

The passing passage 26 is formed on a rear side of the fixing hole 24 to communicate with the fixing hole 24, and supplies the first fluid having been transferred through the transfer passages 52, to the fixing hole 24.

Here, in the present embodiment, the passing passage 26 is formed at a center of the communication passage 50 with respect to a longitudinal cross section of the rotation unit 20. Thus, the transfer passages 52 have a shape of a linear line connecting the communication passage 50 and the passing passage 26 to each other. In particular, in the present embodiment, the plurality of transfer passages 52 are formed radially from the passing passage 26.

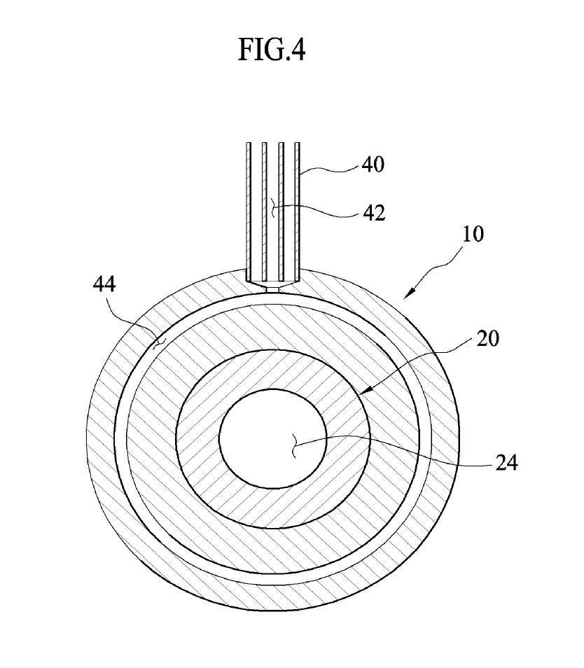

FIG. 4 is a sectional view taken along line B-B of the device for simultaneously supplying fluids according to the embodiment of the present invention.

As illustrated in FIG. 4, the second fluid having flowed through the second passage 42 is transferred to the connection passage 44 formed in the fixing unit 10 and is transferred to the spraying units 41 which have been described above.

In this way, because the connection passage 44 surrounds the rotation unit 20, and has a circular shape sharing a central point, the spraying units 41 may be spaced apart from the central point of the rotation unit 20 by a uniform distance.

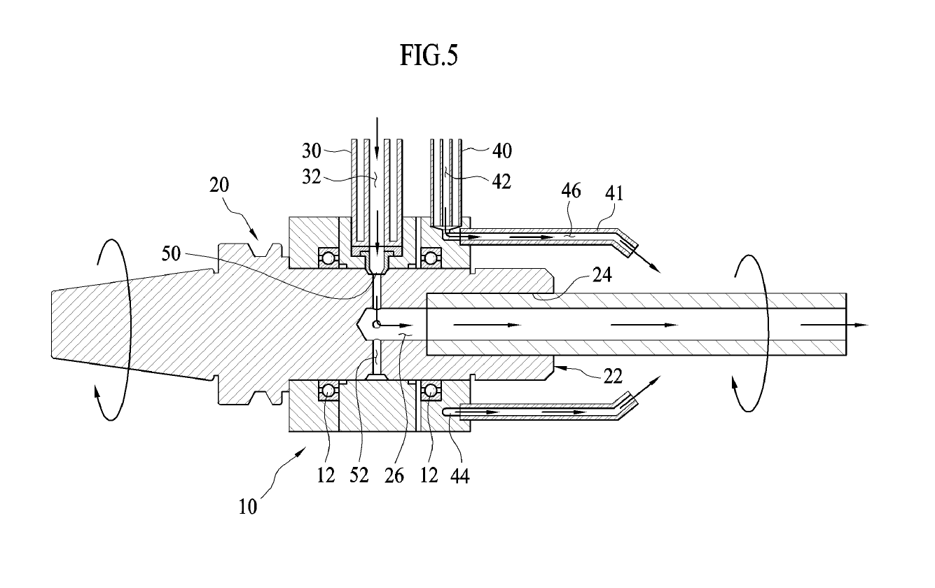

FIG. 5 is a sectional view illustrating a flow path of fluid, in the device for simultaneously supplying fluids according to the embodiment of the present invention.

As illustrated in FIG. 5, because the communication part of the rotation unit 20 includes the communication passage 50 formed to have a circular shape along a circumference thereof, the first fluid having flowed from the first passage 32 may be transferred to the communication passage 50 regardless of a rotation angle of the rotation unit 20.

Thus, the first fluid passes through an inside of the communication part and is transferred to the processing tool 5 fixed to the fixing hole 24.

Here, as described above, the hollow hole 7 may be formed in the processing tool 5, and accordingly, the first fluid may be supplied to the portion to be processed along the hollow hole 7 of the processing tool 5.

Further, the second fluid having flowed through the second passage 42 is transferred to the connection passage 44 formed in the fixing unit 10 and is then transferred to the spraying passages 46 of the spraying units 41. Thereafter, the second fluid may be supplied to the portion to be processed through the nozzles of the spraying units 41.

In this way, the present invention has advantages in that the plurality of fluids may be simultaneously supplied to the processing tool 5 using one device, so that a space and labor power may be prevented from being wasted, and some fluids are directly supplied from a rear side of the processing tool 5, so that use of the fluids may be minimized.

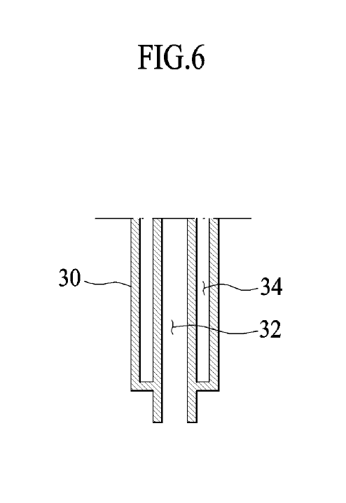

FIG. 6 is a sectional view illustrating the first passage 32 of the device for simultaneously supplying fluids according to the embodiment of the present invention.

As illustrated in FIG. 6, a vacuum part 34 may be formed along a circumference of the first passage 32.

In the present embodiment, because the cryogenic fluid flows through the first passage 32, a phenomenon in which components adjacent to the first passage 32 are frozen may occur, and to prevent this phenomenon, the vacuum part 34 is formed along the circumference of the first fluid 32.

In the present embodiment, the vacuum part 34 has a tube shape surrounding the first passage 32, and accordingly, the first passage 32 may have a shape of entirely a double tube. Further, an inside of the vacuum part 34 is formed in a vacuum state, so that the temperature of the cryogenic fluid flowing through the first passage 32 may be prevented from being transferred to the outside.

Meanwhile, in the present embodiment, the vacuum part is formed in the first passage 32. However, this is merely one embodiment, and the vacuum part 34 may be also formed in the second passage 42.

Hereinabove, the exemplary embodiments of the present invention have described above. It is obvious to those skilled in the corresponding art that the present invention may be specified in different specific forms in addition to the above-described embodiments without departing from the purpose and the scope of the present invention. Therefore, the above-described embodiments are configured to be not restrictive but illustrative, and accordingly, the present invention is not limited to the above descriptions and may be changed within the scope and equivalents of the appended claims.

1. A device for simultaneously supplying fluids, the device comprising:
a fixing unit comprising a first passage through which a first fluid flows, a second passage through which a second fluid flows, and a through-hole;
a rotation unit rotatably provided in the through-hole to pass through the fixing unit, having a fixing hole, into which a processing tool is fixedly inserted, at a front end thereof, having a communication part configured to allow the first passage and the fixing hole to communicate with each other, and configured to supply the first fluid to the processing tool through rotation; and
spraying units connected to the second passage on one sides thereof, having spraying passages having nozzles through which the second fluid is sprayed to a portion to be processed, which is processed by the processing tool, on the other sides thereof, and provided in the fixing unit.

2. The device of claim 1, wherein the fixing unit comprises:
a first connection port connected to a first fluid supply device configured to supply the first fluid and configured to supply the first fluid to the first passage; and
a second connection port connected to a second fluid supply device configured to supply the second fluid and configured to supply the second fluid to the second passage.

3. The device of claim 1, wherein the other side of the first passage is exposed to the through-hole.

4. The device of claim 3, wherein the communication part comprises:
a communication passage formed along a circumference of the rotation unit and configured to communicate with the other side of the first passage; and
transfer passages configured to transfer the first fluid having been transferred to the communication passage through the first passage, to the fixing hole.

5. The device of claim 4, wherein the plurality of transfer passages are formed.

6. The device of claim 4, wherein the communication part further comprises a passing passage which is formed on a rear side of the fixing hole to communicate with the fixing hole and through which the first fluid having been transferred through the transfer passages is supplied to the fixing hole.

7. The device of claim 6, wherein the passing passage is formed at a center of the communication passage with respect to a cross section of the rotation unit.

8. The device of claim 1, wherein a vacuum part for insulation is formed at a circumference of at least one of the first passage and the second passage.

9. The device of claim 8, wherein the vacuum part has a tube shape.

10. The device of claim 1, wherein the plurality of spraying units are provided to surround a circumference of the rotation unit, and
wherein the fixing unit comprises a connection passage allowing the second passage and the spraying passages of the plurality of spraying units to communicate with each other.

11. The device of claim 10, wherein the plurality of spraying units are spaced apart from a central point of the rotation unit by a uniform distance.

12. The device of claim 1, wherein a hollow hole is formed in the processing tool, and
wherein the first fluid having been transferred to the fixing hole is supplied to the portion to be processed through the hollow hole of the processing tool.

13. The device of claim 1, wherein a sealing member configured to prevent leakage of the first fluid is provided between the fixing unit and the rotation unit.
